(19) United States
(12) Patent Application Publication
(10) Pub. No.: US 2009/0055397 A1
(43) Pub. Date: Feb. 26, 2009

(54) Multi-Dimensional Access Control List

(75) Inventors: Kwai Hing Man, Fremont, CA (US); Wai Kei So, Daly City, CA (US)

Correspondence Address: MOLLBORN PATENTS, INC., 2840 COLBY DRIVE, BOULDER, CO, 80305, US

(73) Assignee: International Business Machines Corporation, Armonk, NY (US)

(21) Appl. No.: 11/842,314

(22) Filed: Aug. 21, 2007

(51) Int. Cl. G06F 17/30

(52) U.S. Cl. 707/9; 707/E17.001

(57) ABSTRACT

Methods and apparatus, including computer program products, implementing and using techniques for providing an access control list for an object in a computer system. A list of one or more subjects is defined. Each of the subjects is associated with a set of operations that the subject can perform on the object. A set of rules is defined that specify conditions at which a different set of operations is to be associated with one or more of the subjects in the list of subjects. An access control list is also described.

### BACKGROUND

This invention generally relates to the field of computer security. Access control is an important component in maintaining computer security. One component of the access control in a computer system is an Access Control List (ACL). The ACL specifies the entities that can perform actions in the system, typically referred to as subjects, and the entities representing resources to which access may need to be controlled, typically referred to as objects. The subjects and objects are typically both considered as software entities, rather than as human users, as a human user can only have an effect on the computer system through the software entities that they control.

In a conventional ACL, each entry in the list specifies a subject and an operation, for example, the entry (Alice, delete) on the ACL for file XYZ gives a user Alice permission to delete the file XYZ. When the subject (e.g., Alice) requests to perform an operation on an object (e.g., delete file XYZ), the system first checks the list for an applicable entry in order to decide whether or not to proceed with the operation, and then proceeds in accordance with the ACL entry.

Often, however, there are situations in which the access rights ought to evolve based on factors that are not related to particular users. Currently there is no way to make ACLs adaptive. Instead, separate ACLs must be created. This is both error prone and makes the computer system with many ACLs defined is difficult to manage and maintain for the system administrators. Thus, there is a need for improved ACL mechanisms.

### SUMMARY

In general, in one aspect, the invention provides methods and apparatus, including computer program products, implementing and using techniques for providing an access control list for an object in a computer system. A list of one or more subjects is defined. Each of the subjects is associated with a set of operations that the subject can perform on the object. A set of rules is defined that specify conditions at which a different set of operations is to be associated with one or more of the subjects in the list of subjects.

In general, in another aspect, the invention provides an access control list (ACL) for an object in a computer system. The ACL includes a list of one or more subjects and a set of rules. Each of the subjects is associated with a set of operations that the subject can perform on the object. The set of rules specify conditions at which a different set of operations is to be associated with one or more of the subjects in the list of subjects.

The invention can be implemented to include one or more of the following advantages. In contrast to using multiple ACLs, where each ACL has a dedicated purpose, a single ACL can be used for many purposes and to adapt to changing conditions. This reduces the risk for errors and makes the computer system easy to manage and maintain, thereby lowering the associated administration cost. Troubleshooting operations are also significantly simplified compared to conventional systems.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a document and an associated ACL evolving over a work process, in accordance with one embodiment of the invention.

Like reference symbols in the various drawings indicate like elements.

### DETAILED DESCRIPTION

The various embodiments of the invention relate to improvements over conventional ACLs. In particular, fields are added to the ACL, which specify conditions for when the ACL should evolve. These extra conditions are thus additional dimensions that the ACL must consider. This allows a single ACL to be used for many purposes and to adapt to changing conditions.

Embodiments of the invention will now be described by way of example of a simple work process, involving only a few work nodes, privileges, and people. It should however be realized that in a real life scenario, this process can be extended to much more complex work processes and involve many more privileges and people, as is typical in conventional work processes within corporations and other organizations.

Just like conventional ACLs, the ACLs in accordance with the various embodiments of this invention are initially set up by a computer system administrator. Here, however, the administrator may not only set up static ACLs, as is currently the case, but can also define dynamic conditions that causes the ACL to evolve. For example, a user may have read privileges for a month, and after the month has passed, the user may get both read and write privileges. In three months, the user may also get edit privileges, and in four months, he may obtain delete privileges. This is one example of how an ACL can evolve based on time. As will be seen below, the ACL can also evolve based on factors other than time, for example, if person gets promoted from manager to vice president, then the ACL privileges may change.

In some embodiments, the ACL “evolution conditions” are part of the ACL itself. In other embodiments, the ACL can reference information outside the ACL, where the conditions are specified. For example, if a multi-dimensional ACL in accordance with one embodiment of the invention is a collection of conditions (month of year, for example), then for each month, an external regular ACL can be referenced. Alternatively, if the multi-dimensional ACL is implemented as a collection of conventional ACLs, then the multi-dimensional ACL can point to external conditions (e.g., month). The ACL knows when to evolve based on various mechanisms, such as polling, or through a trigger that gets invoked when a certain system administrator defined condition is fulfilled, such as a retrieve or import operation, and so on.

In a content management system, the ACL can be stored on a library server, similar to conventional ACLs. The library server contains the definitions of what the content management system is capable of doing. Whenever a user tries to perform an operation on an object, the content management system checks with the library server whether the proposed operation is allowed by the ACL.

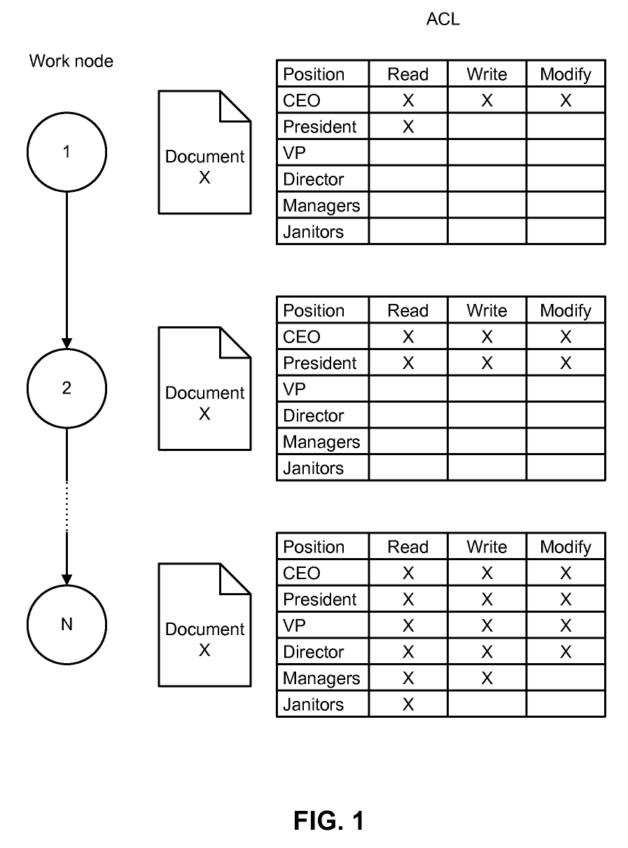

FIG. 1 shows a Document X passing through a workflow process which has N work nodes, labeled 1, 2 . . . N. Document X has an associated ACL, which defines the operations people in various positions can perform on Document X. In the implementation shown in FIG. 1, the ACL contains three types of operations (read, write and modify) for the following groups of people: CEO, President, Vice President, Director, Managers, and Janitors. At each stage of the work flow process, Document X is reviewed and either rejected or approved.

Suppose the CEO initiates Document X in a work process that details an acquisition of a rival company. At Node 1, because it is still early in the potential acquisition, such information should only be disclosed to the CEO and to the president. As such, the ACL for Document X (not the ACL for work node 1) will be used to filter out all access by anyone else, and give the CEO read, write and modify access and give the President read access, as indicated in the ACL. Once approved, Document X proceeds to Node 2, at which the CEO retains the same privileges as in Node 1, and the President is also granted write and modify access. At each subsequent stage of the workflow process, the ACL allows more and more people access, as the proposal outlined in Document X is becoming more realistic, and thus can be publicized.

As can be seen in the above example, in this case, a set of privileges is associated with a particular group of people. For each privilege, a condition can be assigned. If that condition is met, the privilege can be enabled or disabled. In the above case with the acquisition process, the condition is the current stage of the acquisition process. That is, different level of access is granted to different people during different stages of the acquisition process.

Furthermore, it is important to note that in the above example, there is only a single ACL throughout all the work nodes, unlike current implementations, in which a separate ACL is needed for each work node. This distinction is important, as in a typical real-life computer system the number of work nodes (and thus the number of ACLs) grows to be extremely large. With the design in accordance with the embodiments described herein, only one ACL will be necessary.

In the above example, the ACL evolved based on the nodes in the workflow process, but more generally speaking, the ACL can evolve based on a variety of factors. For example, the ACL can evolve based on time, work process, last modified time, who last modified the ACL, who last accessed the ACL, how many versions the ACL has, and so on. With this ability to adapt, ACLs become much easier to manage and use.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, the various embodiments of the invention have been described above with reference to accessing documents in a computer system. However, it should be clear that the same principles can be applied within other areas as well. For example, the ACLs can be implemented in car keys, which are primarily electronic these days, and only allow unlocking of the doors to the car and starting of the engine if certain conditions are fulfilled, e.g., depending on the sobriety of the driver, the time of day, and so on. Accordingly, other embodiments are within the scope of the following claims.

1. An access control list for an object in a computer system, comprising:
a list of one or more subjects, each of the subjects being associated with a set of operations that the subject can perform on the object; and
a set of rules specifying conditions at which a different set of operations is to be associated with one or more of the subjects in the list of subjects.

2. The access control list of claim 1, wherein the access list has a first initial state and a second state that is entered in response to fulfilling one or more of the conditions.

3. The access control list of claim 1, wherein the one or more subjects include one or more user profiles defined in the computer system.

4. The access control list of claim 1, wherein only a single access control list is associated with each object in the computer system.

5. The access control list of claim 1, wherein the object is a computer file representing a document, and the operations include one or more of: create document privileges, read privileges, write privileges, modify privileges and delete privileges for the document.

6. The access control list of claim 1, wherein the access control list is stored on a library server in the computer system.

7. A computer-implemented method for providing an access control list for an object in a computer system, the method comprising:
defining a list of one or more subjects;
associating each of the subjects with a set of operations that the subject can perform on the object; and
defining a set of rules specifying conditions at which a different set of operations is to be associated with one or more of the subjects in the list of subjects.

8. The method of claim 7, further comprising:
evolving the access list from a first initial state to a second state in response to detecting that one or more of the conditions is fulfilled.

9. The method of claim 7, wherein the one or more subjects include one or more user profiles defined in the computer system.

10. The method of claim 7, wherein only a single access control list is associated with each object in the computer system.

11. The method of claim 7, wherein the object is a computer file representing a document, and the operations include one or more of: create document privileges, read privileges, write privileges, modify privileges and delete privileges for the document.

12. The method of claim 7, further comprising storing the access control list on a library server in the computer system.

13. A computer program product comprising a computer useable medium including a computer readable program, wherein the computer readable program when executed on a computer causes the computer to:
define a list of one or more subjects;
associate each of the subjects with a set of operations that the subject can perform on the object; and
define a set of rules specifying conditions at which a different set of operations is to be associated with one or more of the subjects in the list of subjects.

14. The computer program product of claim 13, further causing the computer to:
evolve the access list from a first initial state to a second state in response to detecting that one or more of the conditions is fulfilled.

15. The computer program product of claim 13, wherein the one or more subjects include one or more user profiles defined in the computer system.

16. The computer program product of claim 13, wherein only a single access control list is associated with each object in the computer system.

17. The computer program product of claim 13, wherein the object is a computer file representing a document, and the operations include one or more of: create document privileges, read privileges, write privileges, modify privileges and delete privileges for the document.

18. The computer program product of claim 13, further causing the computer to store the access control list on a library server in the computer system.
